(19) United States
(12) Patent Application Publication
(10) Pub. No.: US 2026/0317916 A1
(43) Pub. Date: Oct. 15, 2026

(54) METHOD FOR PREPARING IRON AND SILICATE SLAG FROM COPPER SLAG

(71) Applicant: Shanghai University, Shanghai (CN)

(72) Inventor: Qiang ZHEN, Shanghai (CN)

(21) Appl. No.: 19/444,622

(22) Filed: Jan. 9, 2026

(30) Foreign Application Priority Data
Mar. 21, 2025 (CN) 202510336517.6

(51) Int. Cl. C25B 1/33

(52) U.S. Cl. CPC C25B 1/33

(57) ABSTRACT

Disclosed is a method for preparing iron and silicate slag from copper slag. The method includes: subjecting molten copper slag to electrolysis to obtain the iron and the silicate slag, where the molten copper slag has a temperature of 1200° C. to 1400° C.

### CROSS REFERENCE TO RELATED APPLICATION

This patent application claims the benefit and priority of Chinese Patent Application No. 202510336517.6 filed with the China National Intellectual Property Administration on Mar. 21, 2025, the disclosure of which is incorporated by reference herein in its entirety as part of the present application.

### TECHNICAL FIELD

The present disclosure belongs to the technical field of solid waste resource utilization, and in particular relates to a method for preparing iron and silicate slag from copper slag.

### BACKGROUND

Copper slag is a secondary tailing discarded by copper smelting after beneficiation. Currently, a method for treating copper slag involve providing copper slag as a raw material, and adding a modifier containing an alkali metal oxide into the molten copper slag or controlling the atmosphere by blowing gas into the molten copper slag to obtain iron concentrate powder and tailings. The iron recovery rate is low in iron concentrate powder prepared by this method. Therefore, how to improve the method to increase the iron recovery rate has become an urgent technical problem to be solved in the field.

### SUMMARY

It is an object of the present disclosure to provide a method for preparing iron and silicate slag from copper slag. The method according to the present disclosure could improve the iron recovery rate.

To achieve the above object, the present disclosure provides the following technical solutions:

The present disclosure provides a method for preparing iron and silicate slag from copper slag, including:

subjecting molten copper slag to electrolysis to obtain the iron and the silicate slag, wherein the molten copper slag has a temperature of 1200° C. to 1400° C.

In some embodiments, a total iron content in the molten copper slag is in a range of 20 wt % to 46 wt %.

In some embodiments, the molten copper slag has the temperature of 1300° C. to 1400° C.

In some embodiments, the electrolysis is conducted at a voltage of 0.4 V to 10 V and a current of 0.1 A to 10 A for 0.5 hours to 3 hours.

In some embodiments, the electrolysis is conducted at the voltage of 1V to 6 V, and the current of 1 A to 9 A for 2 hours.

In some embodiments, the electrolysis voltage is conducted at the voltage of 4.8 V to 5.8 V.

In some embodiments, a cathode and an anode used in the electrolysis are independently made of materials including at least one selected from the group consisting of graphite, platinum, rhodium, iridium, silicon carbide, and molybdenum silicide.

In some embodiments, the cathode and the anode used in electrolysis are made of graphite.

In some embodiments, the silicate slag is used to prepare silicate building materials by a fusion casting process.

In some embodiments, the iron is recovered for steel production.

The present disclosure provides a method for preparing iron and silicate slag from copper slag, including: subjecting molten copper slag to electrolysis to obtain the iron and the silicate slag, where the molten copper slag has a temperature of 1200° C. to 1400° C. In the present disclosure, the high-temperature electrolysis of copper slag in its molten state enables sufficient reduction of iron oxides to iron, thus improving the recovery rate of iron. Experimental results show that the method according to the present disclosure yields an iron recovery rate of 80.51% to 95.52%.

### BRIEF DESCRIPTION OF THE DRAWINGS

FIG. 1 shows an X-ray Diffraction (XRD) spectrum of the iron prepared in Example 1; and

FIG. 2 shows an XRD spectrum of the iron prepared in Example 2.

### DETAILED DESCRIPTION OF THE EMBODIMENTS

The present disclosure provides a method for preparing iron and silicate slag from copper slag, including: subjecting molten copper slag to electrolysis to obtain the iron and the silicate slag, where the molten copper slag has a temperature of 1200° C. to 1400° C.

In the present disclosure, there are no specific limitations on the source of raw materials, and commercially-available products well known to those skilled in the art may be used.

In some embodiments of the present disclosure, the molten copper slag is a freshly tapped slag obtained from copper smelting plants.

In some embodiments of the present disclosure, a total iron content in the molten copper slag is in a range of 20 wt % to 46 wt %. In some embodiments, the total iron content in the molten copper slag is 25 wt %, 30 wt %, 35 wt %, 43.55 wt % or 45 wt %.

In some embodiments of the present disclosure, the molten copper slag has a temperature of 1200° C. 1400° C. In some embodiments, the molten copper slag has the temperature of 1300° C. to 1350° C. In the present disclosure, a thermal energy of the molten copper slag is fully utilized for electrolysis, thereby recovering iron element from the copper slag.

In some embodiments of the present disclosure, the electrolysis is conducted at a voltage of 0.4 V to 10 V. In some embodiments, the electrolysis is conducted at a voltage of 1 V to 6 V. In some embodiments, the electrolysis is conducted at a voltage of 4.8 V to 5.8 V. In some embodiments, the electrolysis is conducted at a current of 0.1 A to 10 A. In some embodiments, the electrolysis is conducted at a current of 1 A to 9 A. In some embodiments, the electrolysis is conducted for 0.5 h to 3 h. In some embodiments, the electrolysis is conducted for 2 h. In the present disclosure, the degree of electrolysis could be improved by limiting the process parameters of electrolysis to the aforementioned range, thereby improving the iron recovery rate.

In some embodiments, the electrolysis is conducted at a voltage of 4.9 V, 5.0 V, 5.1 V, 5.2 V, 5.3 V, 5.4 V, 5.5 V, 5.6 V, or 5.7 V. In some embodiments, the electrolysis is conducted at a current of 2 A, 3A, 4A, 5A, 6A, 7A, or 8 A.

In the present disclosure, a cathode and an anode used in the electrolysis are independently made of materials including at least one selected from the group consisting of graphite, platinum, rhodium, iridium, silicon carbide, and molybdenum silicide. In some embodiments, the cathode and the anode used in the electrolysis are made of graphite.

In some embodiments of the present disclosure, the electrolysis is conducted in a high-temperature reactor. In some embodiments, the high-temperature reactor is made of refractory material. In the present disclosure, there is no specific limitations on the type of the refractory material, and any refractory material that is well known to those skilled in the art may be used.

In some embodiments of the present disclosure, the silicate slag is used to prepare silicate building materials by a fusion casting process. In some embodiments of, the silicate building material is selected from the group consisting of a brick or dense aggregate. In the present disclosure, there is no specific limitations on the operation of preparing silicate building materials by the fusion casting process, and any coating operation that is well known to the skilled in the art may be used.

In some embodiments of the present disclosure, the iron is recovered for steel production. In the present disclosure, 80 wt % or more of the iron oxides in molten copper slag are reduced to iron, which settles in the lower layer, while the silicate slag is in the upper layer.

In the present disclosure, by electrolyzing the molten copper slag, iron elements could be directly recovered from copper slag. The obtained silicate slag could be used to prepare silicate building materials, replacing fired products. The method makes efficient use of iron element and silicate components in molten copper slag, achieving the synergistic utilization of molten copper slag material and thermal energy, improving the resource utilization efficiency of molten copper slag, and reducing carbon emissions in the energy-intensive copper metallurgical industry.

Without additional addition of reducing agents and modifiers, the method according to the present disclosure enables the directly preparation of silicate building materials and iron starting from molten copper slag by electrolytically adjusting the composition of molten copper slag with an applied electric field, realizing a three-way utilization of thermal energy, iron, and slag resources and promoting the reduction of carbon emission in the energy-intensive copper metallurgical industry.

The iron obtained from the present disclosure could be directly recycled in the steel industry. A resulting silicate slag could be used to prepare silicate building materials, bricks, or dense aggregates by a fusion casting process. The synergistic utilization of molten copper slag and thermal energy thereof are achieved, and the resource utilization efficiency of molten copper slag is improved. On one hand, metallurgical waste slag is effectively utilized, the disposal costs are reduced, and the occupation of land resources and environmental pollution caused by slag stockpiling are avoided. On the other hand, CO₂ emissions are reduced, which is conducive to the reduction of carbon emission in the energy-intensive copper metallurgical industry.

According to the present disclosure, the high-temperature electrolysis of copper slag in a molten state enables sufficient reduction of iron oxides to iron, thus improving the iron recovery rate.

The technical solutions in some embodiments of the present disclosure will be described clearly and completely below with reference to the examples of the present disclosure. Apparently, the described examples are merely some, rather than all of the examples of the present disclosure. Based on the examples in the present disclosure, all other examples obtained by those of ordinary skill in the art without involving creative effort belong to the scope of the present disclosure.

The copper slag used in the examples was taken from a copper smelting enterprise.

### Example 1

The method for preparing iron and silicate slag from copper slag was conducted as follows.

Molten copper slag with a temperature of 1400° C. was transferred to a high-temperature reactor made of refractory material. A graphite anode and a graphite cathode were then inserted into the molten copper slag. The molten copper slag was then subjected to electrolysis at a voltage of 4.9 V and a current of 9 A for 2 h to obtain an upper silicate slag and a lower iron. A total iron content in the molten copper slag was 43.55 wt %. The upper silicate slag was used to prepare silicate building materials by a fusion casting process, and the iron was recovered for steel production.

### Example 2

The method for preparing iron and silicate slag from copper slag was conducted as follows.

Molten copper slag with a temperature of 1300° C. was transferred to a high-temperature reactor made of refractory material. A graphite anode and a graphite cathode were then inserted into the molten copper slag. The molten copper slag was then subjected to electrolysis at a voltage of 5.8 V and a current of 9 A for 2 h to obtain an upper silicate slag and a lower iron. A total iron content in the molten copper slag was 43.55 wt %. The upper silicate slag was used to prepare silicate building materials by a fusion casting process, and the iron was recovered for steel production.

### Example 3

The method for preparing iron and silicate slag from copper slag was conducted as follows.

Molten copper slag with a temperature of 1350° C. was transferred to a high-temperature reactor made of refractory material. A graphite anode and a graphite cathode were then inserted into the molten copper slag. The molten copper slag was then subjected to electrolysis at a voltage of 4.8 V and a current of 9 A for 2 h to obtain an upper silicate slag and a lower iron. A total iron content in the molten copper slag was 43.55 wt %. The upper silicate slag was used to prepare silicate building materials by a fusion casting process, and the iron was recovered for steel production.

The iron recovery rate of the molten copper slags prepared in Examples 1-3 was tested and the results are shown in Table 1. The iron recovery rate R_{Fe} was obtained using Equation I:

$${R}_{Fe} = \frac{{C}_{0} - {C}_{1}}{{C}_{0}} ; \qquad Equation I$$

where C₀ refers to the total iron content in the molten copper slag, and C₁ refers to the total iron content in the silicate slag.

TABLE 1
Iron recovery rate of the molten copper
slag prepared in Examples 1-3

| Item | Example 1 | Example 2 | Example 3 |
|---|---|---|---|
| Iron recovery rate (%) | 95.52% | 80.51% | 89.80% |

As can be seen from Table 1, the iron recovery rate is relatively high in the examples, and most of the iron in the molten copper slag is substantially recovered.

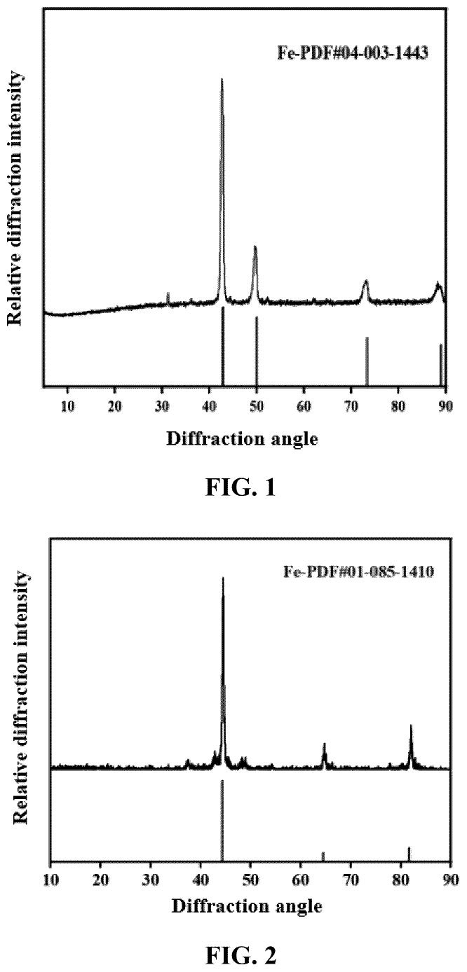

XRD analysis was performed on the lower iron obtained in Examples 1-2, and the results are shown in FIGS. 1-2. FIG. 1 shows an XRD pattern of the iron prepared in Example 1. FIG. 2 shows an XRD spectrum of the iron prepared in Example 2.

As can be seen from FIGS. 1-2, the primary phase is iron with no other impurity peaks, indicating a relatively pure composition.

XRF analysis was performed on the silicate slags prepared in Examples 1-3, and the results are shown in Table 2 (wt %).

TABLE 2
XRF results of the silicate slags prepared in Examples 1-3

| Composition | Fe₂O₃ | SiO₂ | CaO | Al₂O₃ | MgO | Others |
|---|---|---|---|---|---|---|
| Example 1 | 1.81% | 45.82% | 22.89% | 8.66% | 2.92% | 17.90% |
| Example 2 | 7.87% | 42.87% | 21.67% | 8.08% | 3.75% | 15.76% |
| Example 3 | 4.12% | 44.87% | 22.86% | 8.47% | 4.05% | 15.63% |

As can be seen from Table 2, the silicate slags prepared in Examples 1-3 all have a relatively low amount of Fe₂O₃ and good iron reduction effects, and are mainly composed of silicon dioxide and calcium oxide, which could be used to prepare silicate building material bricks or dense aggregates by a fusion casting process.

### Comparative Example 1

This example was conducted essentially the same as those in example 1, expect that a graphite anode and cathode were inserted without applying an electric field.

XRF analysis was performed on the silicate slags prepared in Example 1 and Comparative Example 1, and the results are shown in Table 3 (wt %).

TABLE 3
XRF results of the silicate slags prepared
in Examples 1 and Comparative Example 1

| Component | SiO₂ | Fe₂O₃ | CaO | Al₂O₃ | MgO | Others |
|---|---|---|---|---|---|---|
| Example 1 | 45.82% | 1.81% | 22.89% | 8.66% | 2.92% | 17.90% |
| Comparative | 33.79% | 27.89% | 14.90% | 6.83% | 2.93% | 13.66% |
| Example 1 | | | | | | |

As can be seen from Table 3, Fe₂O₃ in the copper slag was substantially reduced after an electric field was applied in Example 1. By contrast, a large amount of Fe₂O₃ remained in Comparative Example 1, indicating that the reduction effect of graphite on Fe₂O₃ in molten copper slag is limited. However, Fe₂O₃ was effectively reduced through electrolysis, leaving the main components of the silicate slag as SiO₂, CaO and Al₂O₃, with a low Fe₂O₃ content.

In summary, in the present disclosure, the method for electrolyzing molten copper slag makes fully use of the thermal energy of the molten copper slag, and enables the recovery of iron element, and the use of silicate slag to prepare silicate building materials, thus achieving synergistic utilization of both the thermal energy and material components of bulk solid waste. On one hand, metallurgical waste slag is effectively utilized, the disposal costs are reduced, and the occupation of land resources and environmental pollution caused by slag stockpiling are avoided. On the other hand, CO₂ emissions are reduced, which is conducive to the reduction of carbon emission in the energy-intensive copper metallurgical industry.

It can be seen from the above examples that that method according to the present disclosure could improve the iron recovery rate.

The descriptions above are merely the preferred embodiments of the present disclosure. It should be noted that several improvements and modifications may also be made by those of ordinary skill in the art without departing from the principle of the present disclosure, and these improvements and modifications shall also be considered within the scope of the present disclosure.

1. A method for preparing iron and silicate slag from copper slag, consisting of:
subjecting molten copper slag to electrolysis to obtain the iron and the silicate slag, wherein
the molten copper slag has a temperature of 1200° C. to 1400° C.;
the molten copper slag is a freshly tapped slag obtained from copper smelting plants;
the silicate slag is used to prepare silicate building materials by a fusion casting process; and
the electrolysis is conducted at a voltage of 4.8 V to 5.8 V.

2. The method of claim 1, wherein a total iron content in the molten copper slag is in a range of 20 wt % to 46 wt %.

3. The method of claim 1, wherein the molten copper slag has the temperature of 1300° C. to 1400° C.

4. The method of claim 1, wherein the electrolysis is conducted at a current of 0.1 A (ampere) to 10 A for 0.5 hours to 3 hours.

5. The method of claim 1, wherein the electrolysis is conducted at a current of 1 A to 9 A for 2 hours.

6. The method of claim 1, wherein a cathode and an anode used in the electrolysis are independently made of materials comprising at least one selected from the group consisting of graphite, platinum, rhodium, iridium, silicon carbide, and molybdenum silicide.

7. The method of claim 1, wherein a cathode and an anode used in the electrolysis are made of graphite.

8. The method of claim 4, wherein the electrolysis is conducted at the current of 1 A to 9 A for 2 hours.

9. The method of claim 6, wherein the cathode and the anode used in the electrolysis are made of graphite.
